(19) United States
(12) Patent Application Publication
(10) Pub. No.: US 2020/0211379 A1
(43) Pub. Date: Jul. 2, 2020

(54) ROUNDABOUT ASSIST

(71) Applicant: Continental Automotive Systems Inc., Aubum Hills, MI (US)

(72) Inventor: Elena Quijano, Soquel, CA (US)

(21) Appl. No.: 16/721,998

(22) Filed: Dec. 20, 2019

Related U.S. Application Data
(60) Provisional application No. 62/785,408, filed on Dec. 27, 2018.

(51) Int. Cl. G08G 1/08; G08G 1/01; G06N 3/04

(52) U.S. Cl. CPC G08G 1/08; G08G 1/0116; G08G 1/04; G08G 1/0141; G06N 3/04; G08G 1/0133

(57) ABSTRACT

A method and apparatus utilizes a navigation system to identify a roundabout on a route for a primary object about to enter the roundabout. Sensor hardware is mounted at a plurality of locations about the roundabout. A controller determines locations of one or more secondary objects relative to the roundabout using sensor data generated by the sensor hardware, and signals the primary object when it is safe to enter the roundabout and avoid the secondary objects.

### PRIORITY CLAIM

This application claims the benefit of U.S. Provisional Application No. 62/785,408 filed on Dec. 27, 2018.

### TECHNICAL FIELD

The subject invention provides a system and method for informing a primary object when it is safe to enter a roundabout.

### BACKGROUND

One of the most challenging road configurations for drivers is the roundabout. A roundabout or traffic circle is an intersection where a plurality of roads join together, and traffic moves around a circular island area in the middle of the intersection rather than straight across the intersection. Drivers who are unfamiliar with this type of intersection can cause traffic delays or accidents due to difficulties arising from determining when to enter the roundabout. Thus, there is a need to provide further assistance to drivers to facilitate the flow into and out of the roundabout. This will provide increased safety and improved traffic flow.

### SUMMARY

In one exemplary embodiment, a method includes identifying a roundabout on a route for a primary object about to enter the roundabout, determining locations of one or more secondary objects relative to the roundabout, and signaling the primary object when it is safe to enter the roundabout and avoid the secondary objects.

In another embodiment according to the previous embodiment, the primary object comprises a primary vehicle, pedestrian, or biker, and wherein the secondary objection comprises one or more of a secondary vehicle, pedestrian, or biker.

In another embodiment according to any of the previous embodiments, the determining step further includes determining one or more of position, heading, and velocity for each of the secondary objects.

In another embodiment according to any of the previous embodiments, the method includes placing detected secondary objects on a map of the roundabout and using environmental sensor data for the roundabout to determine when it is safe for the primary object to enter the roundabout.

In another embodiment according to any of the previous embodiments, the signaling step further includes signaling the primary object when it is safe to enter the roundabout by one or more of broadcasting information over a communications network, activating a signal light at an entrance to the roundabout, or activating a visual or audible signal associated with the primary object.

In another embodiment according to any of the previous embodiments, the method includes providing a neural network for secondary object detection that uses sensor data from sensor hardware including cameras and/or radar to determine position, heading, and velocity for each of the secondary objects.

In another embodiment according to any of the previous embodiments, the method includes calibrating a system controller with dimensions of the roundabout and locations of the sensor hardware, placing detected secondary objects on a map of the roundabout, and using predetermined criteria such that the system controller can determine when the primary object can enter the roundabout.

In another embodiment according to any of the previous embodiments, the predetermined criteria includes at least a data set for spacing between detected secondary objects and the primary object for a given speed of the detected secondary objects and/or primary object.

In another embodiment according to any of the previous embodiments, the method includes generating a signal to indicate that the primary object can enter the roundabout and broadcasting the signal over a wireless communication network to be received by the primary object or a signal light associated with an entrance to the roundabout.

In another embodiment according to any of the previous embodiments, the method includes mounting sensor hardware at a plurality of locations about the roundabout, communicating sensor data from the sensor hardware to a system controller that determines position, heading, and/or velocity for each of the secondary objects, and maps the secondary objects to the roundabout.

In another embodiment according to any of the previous embodiments, the sensor hardware includes one or more of the following types of sensors: motion sensor, radar sensor, optical camera sensor, lidar sensor, laser sensor, and/or ultrasonic sensor.

In another exemplary embodiment, a navigation system identifies a roundabout on a route for a primary object about to enter the roundabout. Sensor hardware is mounted at a plurality of locations about the roundabout. A controller determines locations of one or more secondary objects relative to the roundabout using sensor data generated by the sensor hardware, and signals the primary object when it is safe to enter the roundabout and avoid the secondary objects.

In another embodiment according to any of the previous embodiments, the primary object comprises a primary vehicle, pedestrian, or biker, and wherein the secondary objection comprises one or more of a secondary vehicle, pedestrian, or biker.

In another embodiment according to any of the previous embodiments, the controller determines one or more of position, heading, and velocity for each of the secondary objects based on the sensor data.

In another embodiment according to any of the previous embodiments, the controller places detected secondary objects on a map of the roundabout and uses the sensor data for the roundabout to determine when it is safe for the primary object to enter the roundabout.

In another embodiment according to any of the previous embodiments, the controller signals the primary object when it is safe to enter the roundabout by one or more of broadcasting information over a communications network, activating a signal light at an entrance to the roundabout, or activating a visual or audible signal associated with the primary object.

In another embodiment according to any of the previous embodiments, the controller is calibrated with dimensions of the roundabout and locations of the sensor hardware, and uses predetermined criteria to determine when the primary object can enter the roundabout.

In another embodiment according to any of the previous embodiments, the predetermined criteria includes at least a data set for spacing between detected secondary objects and the primary object for a given speed of the detected secondary objects and/or primary object.

In another embodiment according to any of the previous embodiments, the sensor hardware includes one or more of the following types of sensors: motion sensor, radar sensor, optical camera sensor, lidar sensor, laser sensor, and/or ultrasonic sensor.

### BRIEF DESCRIPTION OF THE DRAWINGS

The disclosure can be further understood by reference to the following detailed description when considered in connection with the accompanying drawings wherein:

FIG. 1 is a schematic representation of a roundabout incorporating the subject invention.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION OF AN EMBODIMENT

The subject invention provides a system and method for informing a primary object when it is safe to enter a roundabout. The method includes identifying a roundabout on a route for a primary object about to enter the roundabout, determining locations of one or more secondary objects relative to the roundabout, and signaling the primary object when it is safe to enter the roundabout and avoid the secondary objects. The primary object can include a primary vehicle, pedestrian, or biker, and the secondary object can include one or more of a secondary vehicle, pedestrian, or biker. The system and method determine one or more of position, heading, and velocity for each of the secondary objects. Detected secondary objects are placed on a map of the roundabout and environmental sensor data for the roundabout is used to determine when it is safe for the primary object to enter the roundabout. The primary object can be signaled that it is safe to enter the roundabout by one or more of broadcasting information over a communications network, activating a signal light at an entrance to the roundabout, or activating a visual or audible signal associated with the primary object.

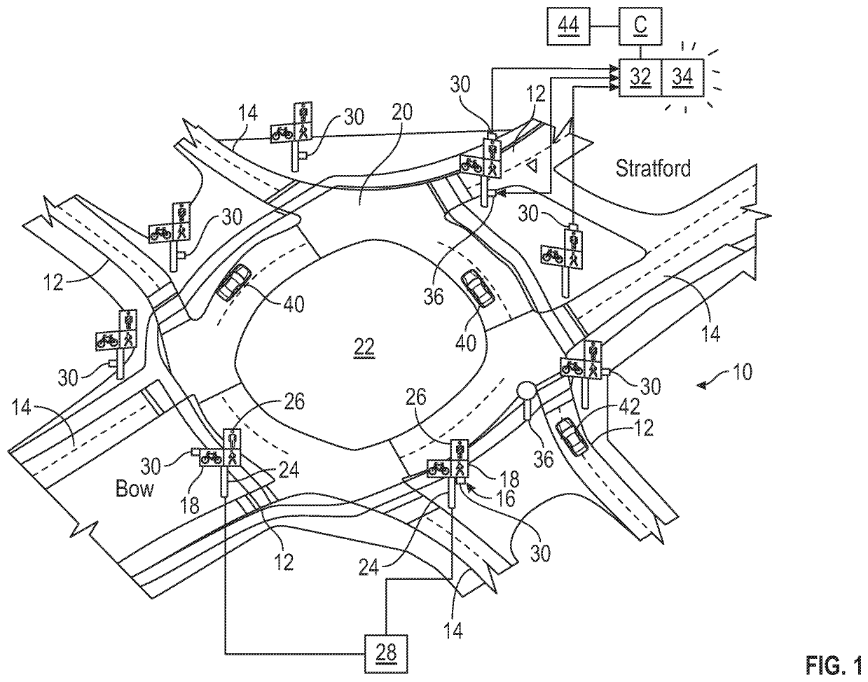

FIG. 1 shows a roundabout 10 having a plurality of first roads 12 entering the roundabout 10 and a plurality of second roads 14 exiting the roundabout 10. A traffic light system 16 includes a plurality of traffic lights or signs 18 that are positioned at corners of the entrances and exits to the roundabout 10. The roundabout includes a circular road 20 extending around an island 22 that connects to all of the entrances and exits of the roads 12, 14. In one example, the traffic lights or signs 18 include at least one main pole 24 that extends upwardly from the ground and supports one or more illuminated indicators 26. The illuminated indicators 26 can comprise bike symbols, pedestrian symbols, red/yellow/green/vehicle traffic lights, etc. The main pole 24 may also include additional traffic lights or signs on secondary poles or arms. A control system 28 controls operation of the traffic lights and signs 18.

Ambient or environmental sensor systems provide data to autonomous vehicles such that the vehicles can follow lanes, avoid collisions, re-route around traffic, etc. These systems can also communicate data to driver-operated vehicles to provide updates regarding weather, traffic, road conditions, emergency warnings, etc. The sensor systems include various types of sensors that are mounted to infrastructure (traffic lights, signs, parking meters, etc.) near intersections, along roads, and on buildings. The sensor systems are used to recognize lane and crosswalk boundaries, and can also be used to determine distances between vehicles and/or other objects that are stationary or moving in or along the road.

In one example, ambient or environmental sensors 30 are mounted to infrastructure, such as the traffic pole 24 or illuminated indicators 26, located around the roundabout 10. A system 32 has a controller C that uses data from the sensors 30 to track stationary or moving objects to determine an object position. Thus, the sensors 30 are used to identify the location of fixed objects/structures such as lanes, crosswalks, parking spaces, etc., and to track and determine the position of moving objects (pedestrians, bikers, vehicles, etc.). In one example, the system uses ambient/environmental sensors 30 that comprise one or more of the following: motion sensor, radar sensor, optical camera sensor, lidar sensor, laser sensor and/or ultrasonic sensor. The sensors 30 capture location and movement information from pedestrians and vehicles in relation to other vehicles, pedestrians, or infrastructure such that this information can be broadcast over a communication system 34 such as Dedicated Short Range Communications (DSRC). DSRC is an open source protocol for wireless communication between vehicles and infrastructure.

One example of this type of communication system is referred to as “vehicle-to-everything (V2X)” communication, and includes the passing of information from a vehicle to any entity that may affect the vehicle, and vice versa. It is a vehicular communication system that incorporates other more specific types of communication such as V2I (vehicle-to-infrastructure), V2N (vehicle-to-network), V2V (vehicle-to-vehicle), V2P (vehicle-to-pedestrian), V2D (vehicle-to-device), and V2G (vehicle-to-grid). This type of communication improves road safety and traffic efficiency, as well as providing energy savings.

The communication system 34 wirelessly communicates via the V2X communication systems to exchange information with surrounding vehicles or infrastructure devices. The V2X messages sent by the vehicles usually comprise at least an absolute position, an absolute speed, and a piece of information about the direction of travel. The V2X messages sent by the system 32 usually comprise moving object positions and stationary object positions (lane location, crosswalk location, parking space locations, etc.). For the V2X communication system to send and/or receive messages and/or information, the system can use one or more of the following connection classes: WLAN connection, e.g. based on IEEE 802.11, ISM (Industrial, Scientific, Medical Band) connection, Bluetooth® connection, ZigBee connection, UWB (ultrawide band) connection, WiMax® (Worldwide Interoperability for Microwave Access) connection, infrared connection, mobile radio connection, and/or radar-based communication.

The subject invention detects and tracks vehicles 40 in the roundabout 10 and signals to drivers of an entering vehicle 42 when it is safe to enter the roundabout, which improves safety and traffic flow. The entering vehicle 42 includes a navigation system 44 that is in communication with the controller C of the system 32 such that the system 32 can identify that the roundabout is on the upcoming path of the entering vehicle 42. The navigation system 44 can be a vehicle installed system or can be part of a wireless communication device that is associated with the driver. In one example, the system 32 utilizes the sensors 30, e.g. cameras, radar, etc., computing modules, and communication hardware mounted to the infrastructure, e.g. traffic lights and poles, to determine when it is safe to enter the roundabout 10. A neural network is used for vehicle detection, and computer vision algorithms are deployed on detected objects to compute relevant metrics, such as position, heading, and velocity for example. Following fusion of the camera and radar data, i.e. compilation of the data from the sensors 30, detected objects can be placed on a map of the roundabout. The system 32, calibrated to the dimensions of the roundabout and locations of the mounted sensing hardware, uses the sensor data, roundabout dimensions, map state, and known timing information (i.e. for a given velocity, a vehicle needs to be X meters away for a second vehicle to safely enter the roundabout) to compute if it is safe for a waiting vehicle 42 to enter. This information is then broadcast over the air via the communication system 34, such as DSRC or V2X, or is signaled via a light switch 36 installed at each entrance to the roundabout 10.

The system 32 can be a separate system or can be incorporated as part of the control system 28 for the traffic lights or signs 18. The system(s) can include one or more controllers C comprising a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller may be a hardware device for executing software, particularly software stored in memory. The controller can be a custom made or commercially available processor, a central processing unit (CPU), an auxiliary processor among several processors associated with the computing device, a semiconductor based microprocessor (in the form of a microchip or chip set), or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

The controller can be configured to execute software stored within the memory, to communicate data to and from the memory, and to generally control operations of the computing device pursuant to the software. Software in memory, in whole or in part, is read by the processor, perhaps buffered within the processor, and then executed.

As discussed above, the subject system 32 uses environmental sensor data from radar and cameras for example, to detect and track vehicles in a roundabout 10. The system 32 then places any detected secondary objects on a map of the roundabout and uses environmental sensor data and known timing information for the dimensioned roundabout to determine when it is safe for the primary object, e.g. vehicle, bike, or pedestrian, to enter the roundabout. This can be communicated via a broadcast or by a visual/audible signal. The result is improved safety and traffic flow.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A method comprising:
(a) identifying a roundabout on a route for a primary object about to enter the roundabout;
(b) determining locations of one or more secondary objects relative to the roundabout; and
(c) signaling the primary object when it is safe to enter the roundabout and avoid the secondary objects.

2. The method according to claim 1, wherein the primary object comprises a primary vehicle, pedestrian, or biker, and wherein the secondary objection comprises one or more of a secondary vehicle, pedestrian, or biker.

3. The method according to claim 2, wherein step (b) further includes determining one or more of position, heading, and velocity for each of the secondary objects.

4. The method according to claim 3, including placing detected secondary objects on a map of the roundabout and using environmental sensor data for the roundabout to determine when it is safe for the primary object to enter the roundabout.

5. The method according to claim 4, wherein step (c) further includes signaling the primary object when it is safe to enter the roundabout by one or more of broadcasting information over a communications network, activating a signal light at an entrance to the roundabout, or activating a visual or audible signal associated with the primary object.

6. The method according to claim 1, including providing a neural network for secondary object detection that uses sensor data from sensor hardware including cameras and/or radar to determine position, heading, and velocity for each of the secondary objects.

7. The method according to claim 6, including calibrating a system controller with dimensions of the roundabout and locations of the sensor hardware, placing detected secondary objects on a map of the roundabout, and using predetermined criteria such that the system controller can determine when the primary object can enter the roundabout.

8. The method according to claim 7, wherein the predetermined criteria includes at least a data set for spacing between detected secondary objects and the primary object for a given speed of the detected secondary objects and/or primary object.

9. The method according to claim 8, including generating a signal to indicate that the primary object can enter the roundabout and broadcasting the signal over a wireless communication network to be received by the primary object or a signal light associated with an entrance to the roundabout.

10. The method according to claim 1, including mounting sensor hardware at a plurality of locations about the roundabout, communicating sensor data from the sensor hardware to a system controller that determines position, heading, and/or velocity for each of the secondary objects, and maps the secondary objects to the roundabout.

11. The method according to claim 10, wherein the sensor hardware includes one or more of the following types of sensors: motion sensor, radar sensor, optical camera sensor, lidar sensor, laser sensor, and/or ultrasonic sensor.

12. A system comprising:
a navigation system that identifies a roundabout on a route for a primary object about to enter the roundabout;
sensor hardware mounted at a plurality of locations about the roundabout; and
a controller that determines locations of one or more secondary objects relative to the roundabout using sensor data generated by the sensor hardware, and signals the primary object when it is safe to enter the roundabout and avoid the secondary objects.

13. The system according to claim 12, wherein the primary object comprises a primary vehicle, pedestrian, or biker, and wherein the secondary objection comprises one or more of a secondary vehicle, pedestrian, or biker.

14. The system according to claim 13, wherein the controller determines one or more of position, heading, and velocity for each of the secondary objects based on the sensor data.

15. The system according to claim 14, wherein the controller places detected secondary objects on a map of the roundabout and uses the sensor data for the roundabout to determine when it is safe for the primary object to enter the roundabout.

16. The system according to claim 15, wherein the controller signals the primary object when it is safe to enter the roundabout by one or more of broadcasting information over a communications network, activating a signal light at an entrance to the roundabout, or activating a visual or audible signal associated with the primary object.

17. The system according to claim 15, wherein the controller is calibrated with dimensions of the roundabout and locations of the sensor hardware, and uses predetermined criteria to determine when the primary object can enter the roundabout.

18. The system according to claim 17, wherein the predetermined criteria includes at least a data set for spacing between detected secondary objects and the primary object for a given speed of the detected secondary objects and/or primary object.

19. The system according to claim 12, wherein the sensor hardware includes one or more of the following types of sensors: motion sensor, radar sensor, optical camera sensor, lidar sensor, laser sensor, and/or ultrasonic sensor.
